(19) United States
(12) Patent Application Publication
(10) Pub. No.: US 2008/0117506 A1
(43) Pub. Date: May 22, 2008

(54) Three-dimensional image forming screen

(76) Inventor: Hae-Yong Choi, Seoul-City (KR)

Correspondence Address: BACON & THOMAS, PLLC, 625 SLATERS LANE, FOURTH FLOOR, ALEXANDRIA, VA, 22314, US

(21) Appl. No.: 11/798,660

(22) Filed: May 16, 2007

(30) Foreign Application Priority Data
Nov. 16, 2006 (KR) 10-2006-0113089

(51) Int. Cl. G03B 21/60; G03B 21/58

(52) U.S. Cl. 359/449; 359/460; 359/461

(57) ABSTRACT

Disclosed is a three-dimensional image forming screen in which, on the basis of a screen substrate having functions of scattering and transmission, polarizing lines for separating and transmitting left and right images from projectors are formed at one surface of the screen substrate and curved surface lines are formed at the other surface of the screen substrate to have the same direction and size as those of the polarizing lines. With this configuration, scattering and transmission of light, separation, transmission, and combination of left and right images, and expansion of the separated images are performed by the single screen, so as to achieve a wide viewing angle of the screen and to allow a viewer to watch a three-dimensional image having a high vividness without assistance of polarizing glasses. When being coupled with a rotating rod that is rotated by a motor, the three-dimensional image forming screen takes the form of a roll-up screen. Alternatively, when being coupled with a frame, the three-dimensional image forming screen can achieve a good flatness.

### BACKGROUND OF THE INVENTION

1. Field of the Invention

The present invention relates to a three-dimensional image forming screen for use with a general projector, and more particularly, to a three-dimensional image forming screen which can allow a viewer to watch a three-dimensional image with his/her naked eyes without an auxiliary device such as polarizing glasses.

2. Description of the Related Art

Conventionally, some image forming apparatuses using an image display, such as a plasma display panel (PDP) or liquid crystal display (LCD), have been developed and used to provide a viewer with a three-dimensional image without assistance of polarizing glasses. However, these conventional image forming apparatuses have a problem in that the size of the display must be increased to obtain a large-size screen and thus, have a limit in the magnification of an image to be formed. Furthermore, the greater the size of the image, the greater the weight and installation area of the conventional image forming apparatuses as well as manufacturing costs must be increased. The conventional image forming apparatuses, accordingly, have a difficulty in their practical use. In particular, the conventional image forming apparatuses have a horizontal viewing angle insufficient to watch a three-dimensional image.

Generally, a projector has a function of easily expanding the size of a screen according to a projection distance thereof.

In a well known conventional method for forming an image in a projection manner, two projectors are used to project a three-dimensional image on a general screen and a polarizing filter is coupled to a front side of a projecting lens provided at each of the projectors.

However, the above described conventional image projection method has a need for separate polarizing glasses in order to watch a three-dimensional image. Further, using the polarizing glasses causes a considerable degradation in the brightness and resolution of the image formed on the screen, and consequently, an increase in the fatigue of the viewer's eyes. In particular, since only viewers wearing the polarizing glasses can watch the three-dimensional image, the conventional image projection method allows only watching of specific persons and is unsuitable for use in general image forming apparatus for the purpose of advertisement, etc.

### SUMMARY OF THE INVENTION

Therefore, the present invention has been made in view of the above problems, and it is an object of the present invention to provide a three-dimensional image forming screen which has functions of: scattering light for allowing images from projectors to be formed on the screen at focal positions; separating left and right images simultaneously with transmission of the images; and combining the finely separated left and right images together, to form a three-dimensional image throughout the screen.

It is another object of the present invention to provide a three-dimensional image forming screen in which left and right images from left and right projectors are separated and expanded to be captured by the viewer's left and right eyes, respectively, for allowing a viewer to watch a three-dimensional image without using separate tools such as polarizing glasses.

In accordance with the present invention, the above and other objects can be accomplished by the provision of a three-dimensional image forming screen using projectors comprising: a transmissive screen as a substrate, the transmissive screen performing scattering and transmission functions simultaneously for the provision of a vivid three-dimensional image without an auxiliary device such as polarizing glasses; a plurality of left and right polarizing lines vertically formed at one surface of the transmissive screen for separating and transmitting left and right images from projectors; and a plurality of curved surface lines vertically formed at the other surface of the transmissive screen to have the same direction and size as those of the polarizing lines, wherein scattering, transmission, fine separation of the left and right images, combination of the separated images are performed by a single screen structure, to achieve a wide viewing angle of the screen and a high vividness of images.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view illustrating important parts of a three-dimensional image forming screen according to an exemplary embodiment of the present invention;

FIG. 2 is a side view illustrating a usage of the three-dimensional image forming screen shown in FIG. 1;

FIG. 3 is a front view of an alternative embodiment of the present invention, illustrating a frame screen structure;

FIG. 4 is a diagrammatic explanatory view illustrating the operation of the image forming screen according to the present invention;

FIG. 5 is a diagrammatic explanatory view illustrating the cross sectional configuration of the image forming screen according to the present invention; and

FIG. 6 is a diagrammatic explanatory view illustrating the configuration of a reflective screen according to the present invention.

### DETAILED DESCRIPTION OF THE PREFERRED EMBODIMENTS

Reference will now be made in detail to the preferred embodiments of the present invention, examples of which are illustrated in the accompanying drawings.

Now, the configuration of a three-dimensional image forming screen 100 according to the present invention will be described in detail with reference to the accompanying drawings.

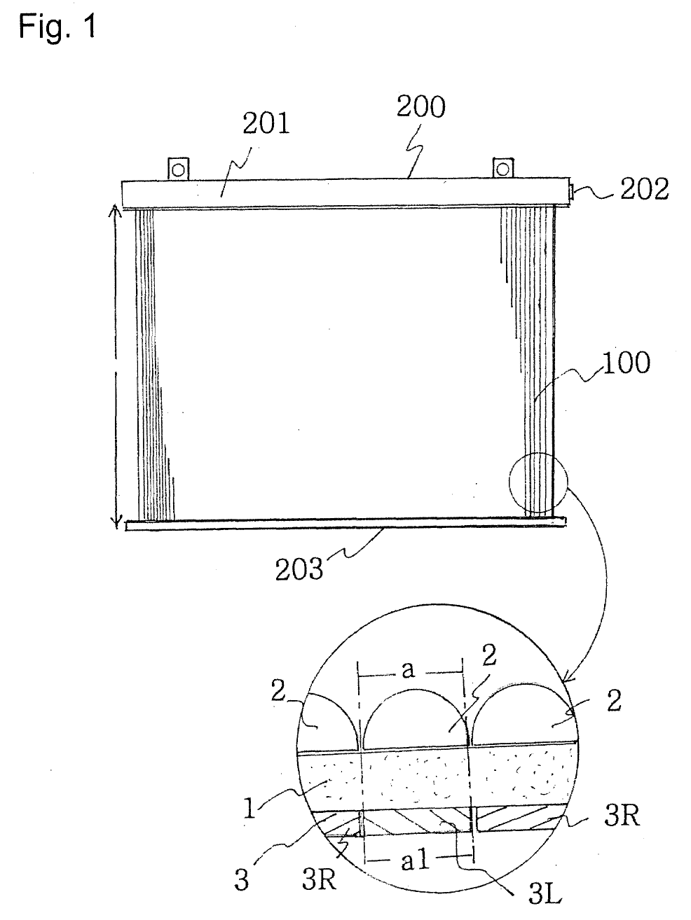

As shown in FIGS. 1, 4, and 5, the three-dimensional image forming screen 100 of the present invention includes a transmissive screen 1 as a substrate. The transmissive screen 1 is made of a transparent thin-film in which a diffusive material is distributed. Instead of using the diffusive material, alternatively, a surface of the transmissive screen 1 may be subjected to an embossing process. The reason why using the diffusive material or embossing process is to provide the transmissive screen 1 with appropriate scattering and transmission functions of incident light.

The transmissive screen 1 has a transmissivity within a range of approximately 10% to 90%, which is adjustable according to the use purpose of the screen 1.

In this case, the transmissive screen 1 has a scattering rate of 90% to 10%. Since the scattering rate is in reverse proportion to a horizontal viewing angle of the screen, an appropriate transmissivity is within a range of 20% to 40%.

Left and right polarizing lines 3R and 3L are vertically formed at a front surface of the transmissive screen 1. Here, the front surface of the transmissive screen 1 is a surface on which a projector projects an image.

The left and right polarizing lines 3R and 3L are linearly formed by use of a polarizing film material such that the left and right polarizing lines 3R and 3L have symmetrical polarizing angles. For example, ones of the left and right polarizing lines 3R or 3L may have a polarizing angle of 45° and the other polarizing lines 3L or 3R may have a polarizing angle of −45°. Alternatively, ones of the left and right polarizing lines 3R or 3L may have a horizontal polarizing angle, and the other polarizing lines 3L or 3R may have a vertical polarizing angle.

The left and right polarizing lines 3R and 3L having the above described configuration are alternately formed at the surface of the transmissive screen 1, so as to be sequentially arranged from the left side to the right side of the transmissive screen 1.

A width (a1) of the left and right polarizing lines 3R and 3L may be changed according to the size of the overall screen 1 within a range of 0.2 mm to 15 mm. Here, the width of 15 mm is equal to the size of a light emitting diode (LED) used in a large-size electronic display board.

The transmissive screen 1 has transparent curved surface lines 2 vertically formed at a rear surface thereof. As shown in FIG. 1, a width (a) of the curved surface lines 2 is equal to the width (a1) of the left and right polarizing lines 3R and 3L.

In summary, on the basis of the transmissive screen 1 as a basic substrate, the left and right polarizing lines 3R and 3L and the transparent curved surface lines 2 are symmetrically formed such that the left and right polarizing lines 3R and 3L are formed at the front surface of the transmissive screen 1 and the curved surface lines 2 are formed at the rear surface of the transmissive screen 1.

The curved surface lines 2 are configured in such a manner that each curved surface line 2 takes the form of a vertically extending line with a horizontally curved surface having a predetermined curvature. When the curvature of the curved surface line 2 is equal to the width of the left and right polarizing lines 3R and 3L, the expansion efficiency of an image increases to the maximum extent and more particularly, by at least 20%.

For example, if the width (a) of the curved surface lines 2 is 1 mm, the diameter of curvature of the curved surface is in a range of 1 to 5 mm.

Specifically, the greater the curvature of the curved surface lines 2, the higher the expansion rate of images. This ensures an improvement in the separation efficiency of left and right images, and consequently, in the sensitivity of a three-dimensional image.

The left and right polarizing lines 3R and 3L of the transmissive screen 1 have the same polarizing angle as that of left and right polarizing plates 4R and 4L provided at left and right projectors 5R and 5L.

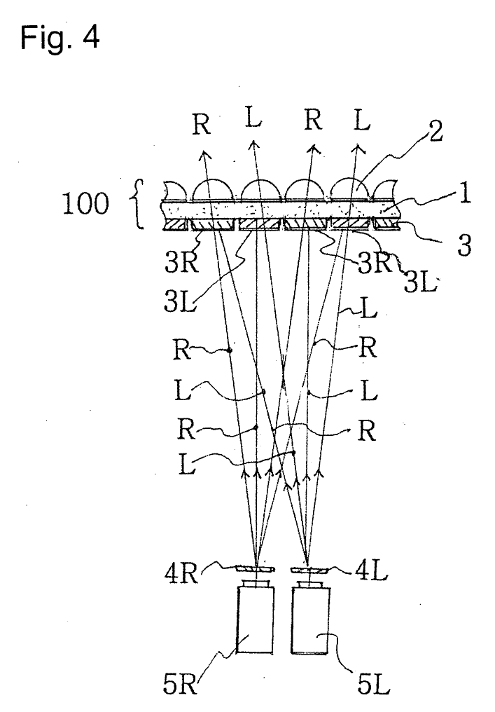

Accordingly, as shown in FIG. 4, of the left and right polarizing lines 3R and 3L alternately arranged in sequence at the front surface of the transmissive screen 1, the right polarizing lines 3L act to intercept a left image R if the left image R is projected from the left projector 5R and polarized by the left polarizing plate 4R, whereas the left polarizing lines 3R act to transmit the left image R, to enable formation of the left image R on the transmissive screen 1.

Similarly, if a right image L is projected from the right projector 5L and polarized by the right polarizing plate 4L, the right image L is intercepted by the left polarizing lines 3R, but is transmitted by the right polarizing lines 3L, so as to be formed on the transmissive screen 1.

The left and right images R and L, which are formed on the transmissive screen 1 as stated above, are expanded by the respective curved surface lines 2 provided at the rear surface of the transmissive screen 1 as the left and right images R and L go straight ahead. Then, the left and right images R and L are sequentially combined while being expanded up to the unit of a pixel by the fine curved surface lines 2, thereby allowing a viewer to watch a three-dimensional image without polarizing glasses.

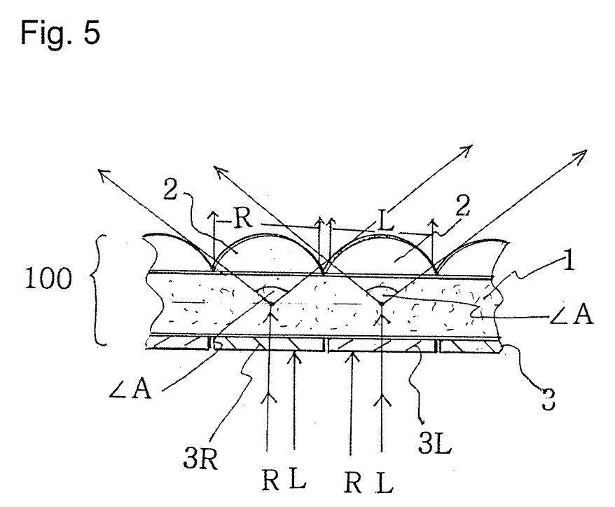

In this case, the transmissive screen 1 acts to scatter incident light from a projector leftward and rightward by an angle ∠A shown in FIG. 5, resulting in a very wide viewing angle ∠A of a three-dimensional image.

When the transmissive screen 1 has a transmissivity of approximately 20%, the scattering rate of the transmissive screen 1 is up to 80and thus, the viewing angle ∠A is approximately 144° corresponding to 80% of 180°. Accordingly, the transmissive screen 1 can achieve a viewing angle of more than three times of 40° that is a standard viewing angle of a conventional flat panel display.

Since the image, which is formed on the transmissive screen 1 included in the three-dimensional image forming screen 100, is expanded by the curved surface lines 2 at the rear surface of the transmissive screen 1 and outside light is diffused to the outside at the surface of the curved surface lines 2, the three-dimensional image forming screen 100 of the present invention has an advantage in that it can achieve an image having a brightness and vividness of more than two times that of a conventional three-dimensional image.

### First Embodiment

Of constituent elements of the three-dimensional image forming screen 100, the left and right polarizing lines 3R and 3L are made of a film material, and the curved surface lines 2 are made of a soft material, such as a transparent silicone rubber or urethane material, to allow the overall three-dimensional image forming screen 100 to be rolled up.

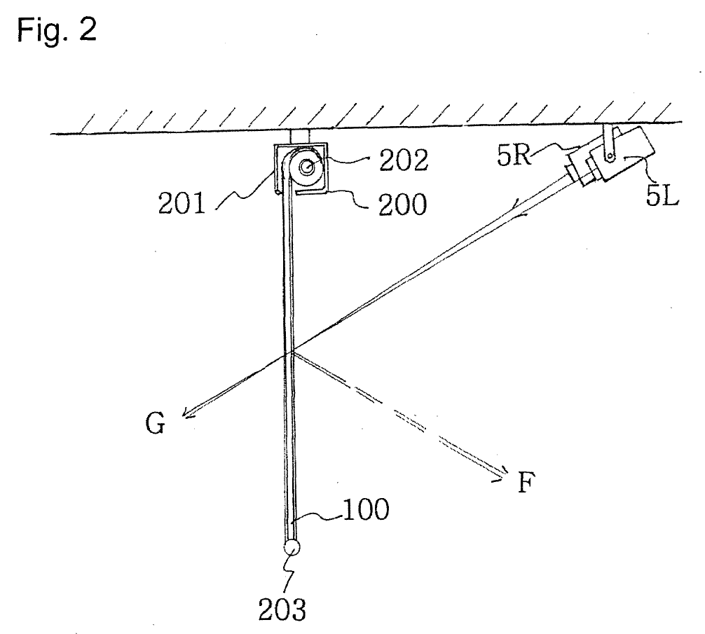

As shown in FIGS. 1 and 2, a screen case 201 that is capable of receiving the three-dimensional image forming screen 100, a rotating rod 202 around which an upper end of the three-dimensional image forming screen 100 is wound, the rotating rod 202 being rotated by a motor, etc., and a lower end rod 203 for supporting a lower end of the three-dimensional image forming screen 100 are coupled to the three-dimensional image forming screen 100, so as to constitute a roll-up type three-dimensional image forming screen.

### Second Embodiment

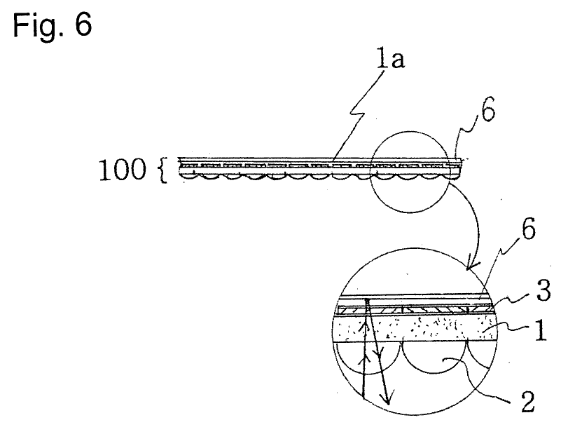

Referring to FIG. 6, a reflective layer 6 may be added to the rear surface of the three-dimensional image forming screen 100.

In this case, the transmissive screen 1 is formed at the front surface thereof with the curved surface lines 2 and at the rear surface thereof with the left and right polarizing lines 3R and 3L, and the reflective layer 6 is added to the rear surface of the left and right polarizing lines 3R and 3L, so as to constitute a reflective screen.

In the present embodiment, as shown in FIG. 6, if an image is incident on the curved surface lines 2, the image is formed on the transmissive screen 1 and reflected by the reflective layer 6 after passing through the left and right polarizing lines 3R and 3L.

### Third Embodiment

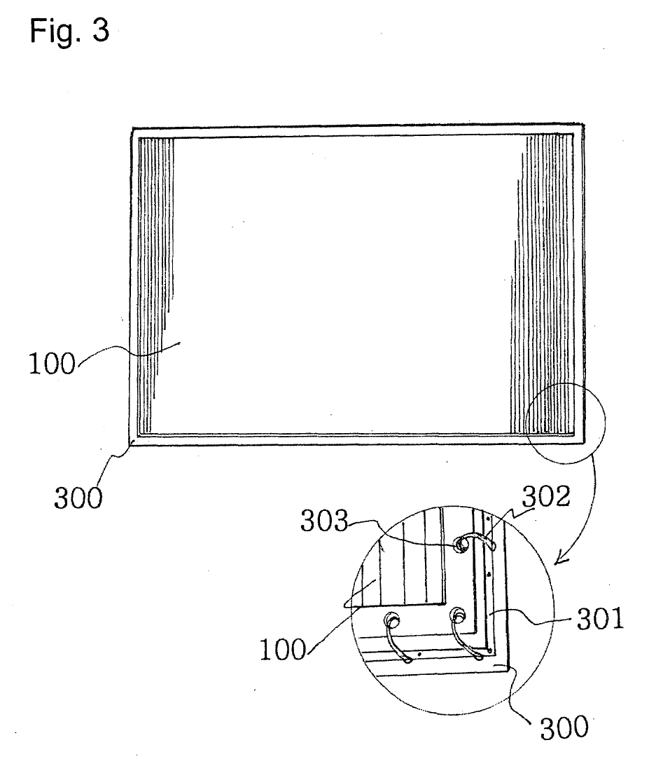

Referring to FIG. 3, the three-dimensional image forming screen 100 may be coupled to a frame 300.

Generally, if a screen has a poor flatness, the uniformity of a three-dimensional image is deteriorated.

Accordingly, after punching holes in a periphery of the three-dimensional image forming screen 100 by a predetermined interval, a screen tightening wire 302, such as a spring or rubber string, is penetrated through the punched holes to be connected to a fixing bar 301 inside the frame 300. Thereby, the transmissive screen 1 can be coupled to the frame 300 such that the transmissive screen 1 is elastically pulled in all directions.

With the above described configuration, the transmissive screen 1 has a very good flatness and thus, is suitable for use in a very large screen having a diagonal length of more than 2 m.

In the above described configuration of the three-dimensional image forming screen 100, the arrangement order of the transmissive screen 1, reflective layer 6, and left and right polarizing lines 3R and 3L may be changed if necessary, and even in this case, the three-dimensional image forming screen 100 can achieve the same effect as the above description.

Also, within the logic scope of the present invention, the left and right polarizing lines 3R and 3L provided at the surface of the three-dimensional image forming screen 100 may be replaced by a parallax barrier type polarizing structure.

As apparent from the above description, according to the present invention, two projectors having polarizing filters are used to project left and right images on a transmissive screen such that a viewer can watch a three-dimensional image formed on the three-dimensional image forming screen of the present invention without using separate polarizing glasses. With the present invention, a viewing angle required for watching a three-dimensional image can be increased more than three times that of the prior art, and vividness of the image can be increased more than two times that of the prior art.

Further, since the three-dimensional image forming screen of the present invention is made of a soft material, such as a film material, the screen can take the form of a roll-up screen if necessary.

Alternatively, the three-dimensional image forming screen may be coupled to a separate frame, so as to constitute a large-scale screen having a good flatness.

The three-dimensional image forming screen according to the present invention can achieve a vivid large-scale three-dimensional image and thus, efficiently used as an advertising apparatus, etc.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A three-dimensional image forming screen using projectors comprising:
a transmissive screen as a substrate, the transmissive screen performing scattering and transmission functions simultaneously;
a plurality of curved surface lines vertically formed at one surface of the transmissive screen; and
a plurality of left and right polarizing lines vertically formed at the other surface of the transmissive screen by use of a polarizing plate,
wherein formation, transmission, polarization, and expansion of images are performed by a single screen structure, to allow a viewer to watch a large-scale three-dimensional image without polarizing glasses.

2. A three-dimensional image forming screen using projectors comprising:
a transmissive screen as a substrate, the transmissive screen performing scattering and transmission functions simultaneously; and
a plurality of curved surface lines and a plurality of left and right polarizing lines vertically formed at front and rear surfaces of the transmissive screen, respectively,
wherein the three-dimensional image forming screen is made of a film material, so as to take the form of a roll-up screen when being used with a rotating rod.

3. The three-dimensional image forming screen according to claim 2, wherein the three-dimensional image forming screen has a good flatness when being used with a frame.

4. A three-dimensional image forming screen using projectors comprising:
a transmissive screen as a substrate, the transmissive screen performing scattering and transmission functions simultaneously;
a plurality of curved surface lines and a plurality of left and right polarizing lines vertically formed at front and rear surfaces of the transmissive screen, respectively; and
a reflective layer formed at a rear surface of the left and right polarizing lines, to provide the three-dimensional image forming screen with a reflection function,
wherein the three-dimensional image forming screen is made of a film material, so as to take the form of a roll-up screen when being used with a rotating rod.

5. The three-dimensional image forming screen according to claim 4, wherein the three-dimensional image forming screen has a good flatness when being used with a frame.
